(19) United States
(12) Patent Application Publication
(10) Pub. No.: US 2024/0229724 A1
(43) Pub. Date: Jul. 11, 2024

(54) ENHANCED ENGINE MODEL FOR CONTROL AND HEALTH MONITORING

(71) Applicant: Raytheon Technologies Corporation, Farmington, CT (US)

(72) Inventors: Liang Tang, Glastonbury, CT (US); Danbing Seto, Avon, CT (US)

(21) Appl. No.: 18/151,939

(22) Filed: Jan. 9, 2023

(51) Int. Cl. F02C 9/00

(52) U.S. Cl. CPC F02C 9/00; F05D 2260/80; F05D 2270/71; F05D 2270/802

(57) ABSTRACT

An engine model calibration system includes a gas turbine engine, a sensor, a nominal engine estimation module for FD&I, and a self-tuning engine estimation module for engine parameter estimation. The nominal engine estimation module includes an open-loop nominal engine model configured to output estimated nominal engine parameters indicative of the one or more engine operating parameters, and selectively updates the open-loop nominal engine model based on one or more identified engine operating conditions. The engine model calibration system can perform calibration of a nominal engine model and a self-tuning engine model as they are used for FD&I and engine parameter estimation. The self-calibrating dynamic model also can separate the long-term tuning parameters and the short-term tuning parameters from one another so that the self-tuning capability for the self-tuning engine model is not compromised or diminished as the engine deteriorates.

### BACKGROUND

Exemplary embodiments of the present disclosure pertain to the art of gas turbine engines, and more particularly to dynamic modeling for control and health monitoring of gas turbine engines.

Dynamic models are commonly used for control and diagnostics of gas turbine engine such as, for example, aircraft engines. Control functions of the aircraft may use the estimated engine parameters generated by the model to establish a closed-loop control system for controlling operating objectives when the model is implemented onboard the aircraft, while the diagnostic functions may rely on the diagnostic features for Fault Detection and Isolation (FD&I). A variety of models have been utilized in the industry including, but not limited to, dynamic state variable models (e.g., linear models or nonlinear models) coupled with a self-tuning function (e.g., a Kalman filter) to match the engine model to the individual engine that is being controlled and monitored.

### BRIEF DESCRIPTION

According to a non-limiting embodiment, an engine model calibration system includes a gas turbine engine, a sensor, and a nominal engine estimation module. The gas turbine engine is configured to operate according to one or more engine operating parameters. The sensor is configured to monitor the gas turbine engine and output measured parameters (Pmas) indicative of the one or more engine operating parameters. The nominal engine estimation module includes an open-loop nominal engine model configured to output estimated nominal engine parameters (Pest) indicative of the one or more engine operating parameters. The nominal engine estimation module identifies one or more engine operating conditions of the gas turbine engine based on the one or more engine operating parameters and selectively updates the open-loop nominal engine model based on the identified one or more engine operating conditions.

Additionally or alternatively, in this or other embodiments the engine model calibration system further comprises a self-tuned engine estimation module including a closed-loop self-tuned engine model configured to output estimated self-tuned engine parameters (P*est) indicative of the one or more engine operating parameters, wherein the self-tuned engine estimation module updates the closed-loop self-tuned engine model based on short-term tuning parameters (ΔηsT) and long-term tuning parameters (ΔηLT).

Additionally or alternatively, in this or other embodiments, the self-tuned engine estimation module further comprises a self-tuning module and a long-term trending deterioration module. The self-tuning module is configured to determine adjusted tuning parameters (Δη) indicative of aggregated adjustments to the closed-loop self-tuned engine model based a difference between the measured parameters (Pmas) and the estimated self-tuned engine parameters (P*est). The long-term trending deterioration module is configured to determine long-term tuning parameters (ΔηLT) based on the adjusted tuning parameters (Δη) and to determine the short-term tuning parameters (ΔηST) based on a difference between the adjusted tuning parameters (Δη) and the long-term tuning parameters (ΔηLT).

Additionally or alternatively, in this or other embodiments, the self-tuned engine estimation module updates the closed-loop self-tuned engine model using the short-term tuning parameters (ΔηST) independently from the long-term tuning parameters (ΔηLT).

Additionally or alternatively, in this or other embodiments, the nominal engine estimation module further comprises a regime recognition module and a calibration adjustment module. The regime recognition module identifies the engine operating conditions. The calibration adjustment module is configured to selectively update the open-loop nominal engine model and the closed-loop self-tuned engine model based on the one or more engine operating conditions identified by the regime recognition module.

Additionally or alternatively, in this or other embodiments, the regime recognition module selects a given calibration model among a plurality of different calibration models based on the identified one or more engine operating conditions, and delivers the selected calibration model to the calibration adjustment module, and the calibration adjustment module updates the open-loop nominal engine model and the closed-loop self-tuned engine model based on the selected calibration model.

Additionally or alternatively, in this or other embodiments, the plurality of different calibration models include an entry into service model that is constructed based on test cell data generated according to an acceptance test, and a service calibration model that is constructed based on flight data collected during operation of the gas turbine engine.

Additionally or alternatively, in this or other embodiments, the regime recognition module initiates a calibration adjustment mode to calibrate the open-loop nominal engine model and the closed-loop self-tuned engine model in response to determining that the identified one or more engine operating conditions were not previously identified.

Additionally or alternatively, in this or other embodiments, the regime recognition module assigns confidence values to the operating conditions of the gas turbine engine and determines when the identified one or more engine operating conditions were not previously identified based the confidence values and a threshold value.

Additionally or alternatively, in this or other embodiments, in response to initiating the calibration mode, the regime recognition module increases the confidence value of the identified operating conditions.

The above described and other features are exemplified by the following figures and detailed description.

Any combination or permutation of embodiments is envisioned. Additional features, functions and applications of the disclosed assemblies, systems and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following descriptions should not be considered limiting in any way. With reference to the accompanying drawings, like elements are numbered alike:

FIG. 1 is a partial cross-sectional view of a gas turbine engine;

FIG. 2 is a diagram depicting an engine model calibration system; and

FIG. 3A is a diagram depicting a memory map at engine entry into service (EIS);

FIG. 3B is a diagram depicting the memory map following a first number of aircraft flights;

FIG. 3C is a diagram depicting the memory map following a second number of aircraft flights;

FIG. 4A is a signal diagram depicting a delta tuner function including long-term engine deterioration parameters (Δη_{LT}) and capped by parameter limits;

FIG. 4B is a signal diagram depicting a delta tuner function that removes the long-term engine deterioration parameters (Δη_{LT}) according to a non-limiting embodiment;

FIG. 5 depicts an example of a signal diagram used by the fault detection module to detect the presence of a fault according to a non-limiting embodiment; and

FIG. 6 is a flow diagram illustrating a method of using and training a service calibration model is illustrated according to a non-limiting embodiment.

### DETAILED DESCRIPTION

A detailed description of one or more embodiments of the disclosed apparatus and method are presented herein by way of exemplification and not limitation with reference to the Figures.

Self-tuning models such as an aircraft on-board engine models (OBEM) utilize tuning parameters, sometimes referred to simply as “tuners”, which are adjustments to various engine's physical parameters including, for example, component efficiencies and flow capacities. When used for diagnostic purpose, however, these self-tuning models often suffer from “tuner contamination,” which refers to a problem that occurs when the self-tuning models attempt compensate for various uncertainties such as engine to engine variation, measurement error, and model infidelity to name a few. Consequently, the tuners essentially lose their physical meanings or physical “truths,” which reduces their value and reliability when performing engine health assessment. One way to preserve the physical meaning of the tuners is to calibrate the model before use so that it absorbs as maximum number of uncertainties as possible. This is usually achieved by using the actual field data in the context of a “Digital Twin” concept and leveraging Machine Learning techniques. However, conventional dynamic model calibration techniques suffer from two significant challenges.

First, the data-driven model calibration requires a large amount of field data for model training to cover the normal operation of the engine which prevents the model from being used at engine entry into service (EIS). Even if a portion of early engine service is dedicated for model calibration, there is no guarantee that all the engine operating conditions are learned, especially for military engines.

Second, even if the model is well-calibrated, and the tuners track the engine physical parameters accurately, the self-tuning capability will diminish proportionally to the engine deterioration. In actual implementation, the tuners are often range limited to prevent undesirable adjustments being applied, which in turn reduces the tunning capabilities, particularly when the engine deterioration gets larger.

One or more non-limiting embodiments described herein overcome the shortcomings found in conventional dynamic model calibration techniques by providing a self-calibrating dynamic model that can be used upon engine EIS and calibrated only when needed. As the engine deteriorates, the long-term deterioration (LTD) is separated from the self-tuning function so that the adjustments of the model remain within the predefined limits. In this manner, the self-tuning capability of the dynamic engine model will be unaffected by the engine deterioration.

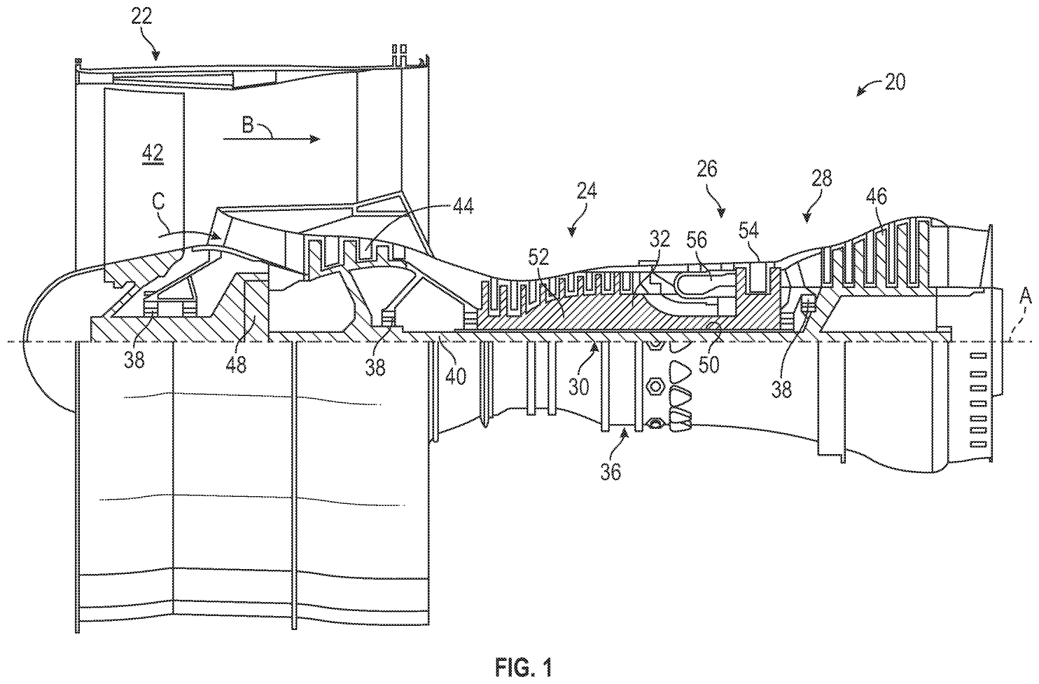

With reference now to FIG. 1 a gas turbine engine 20 is schematically illustrate according to a non-limiting embodiment. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flowpath B in a bypass duct, while the compressor section 24 drives air along a core flowpath C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition--typically cruise at about 0.8 Mach and about 35,000 feet (10,688 meters). The flight condition of 0.8 Mach and 35,000 ft (10,688 meters), with the engine at its best fuel consumption, also known as “bucket cruise Thrust Specific Fuel Consumption (TSFC)”, is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

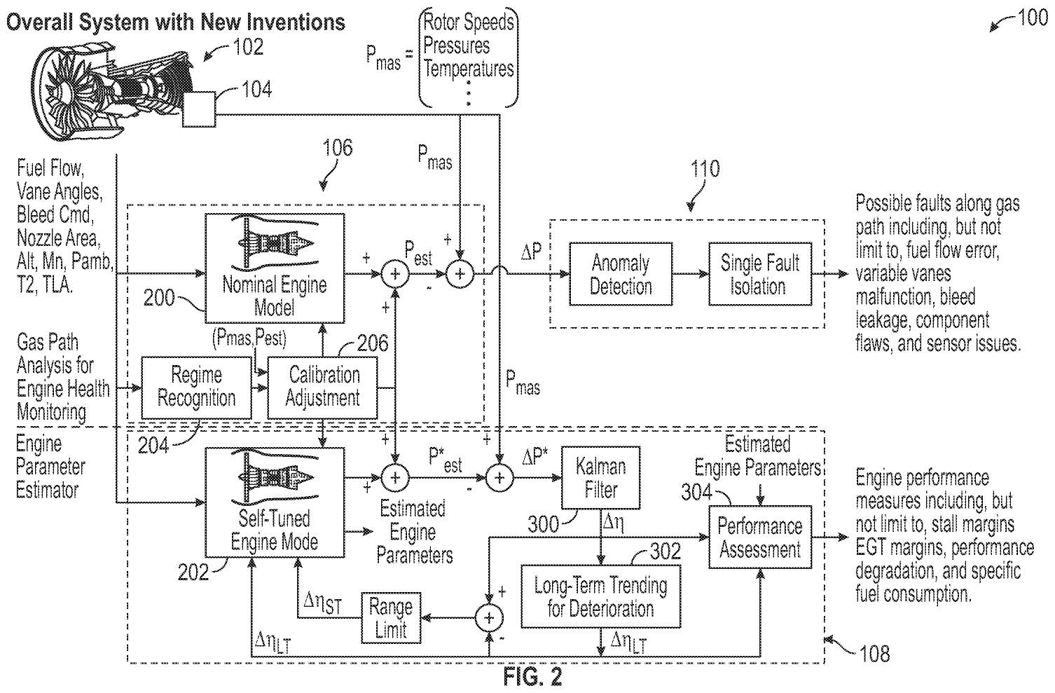

Referring now to FIG. 2, an enhanced engine model system 100 is illustrated according to a non-limiting embodiment. The enhanced engine model system 100 includes a gas turbine engine 102, one or more sensor 104, a nominal engine estimation module 106, a self-tuned engine estimation module 108, and a fault detection and isolation module 110. The gas turbine engine 102 is configured to operate according to one or more engine parameters, the engine parameters including, but not limited to, fuel flow, vane angles, bleed air flow rate, nozzle area, altitude, ambient air pressure, ambient temperature, and throttle lever angle (TLA). The sensors 104 (e.g., a gas path sensor, speed sensors, pressure sensors, temperature sensors, etc.) are configured to monitor operation of the gas turbine engine in real-time and output (e.g., in real-time). Accordingly, one or more of the sensors can output a measured engine parameter signal indicating measured engine parameters (Pₘₐₛ) of the one or more engine parameters, the measured engine parameters (Pₘₐₛ) including, but not limited to, engine rotor speeds, engine pressures, and engine temperatures.

The nominal engine estimation module 106 utilizes one or more on-board engine models (OBEMs) to generate estimated engine parameters representing the measured engine parameters (Pₘₐₛ). The OBEMs include one or more open-loop nominal engine models 200 and the calibration adjustment module 206 working in conjunction with the regime recognition module 204 which are described in greater detail below. The open loop engine model 200 represents a manifestation of what is considered nominal and is used as a reference for measuring engine deviation from it due to failure or deterioration. The open-loop nominal engine model 200 is configured to receive the engine parameters and a set of calibration adjustments to generate estimated engine parameters that can be further adjusted by another set of calibration adjustments to generate nominal estimated engine parameters (Pₑₛₜ) representing the measured engine parameters (Pₘₐₛ). The nominal estimated engine parameters (Pₑₛₜ) can be used as a reference for measuring engine deviation from it, namely, the difference between (Pₘₐₛ) and (Pₑₛₜ), due to failure or deterioration.

The self-tuning engine estimation module 108 utilizes one or more on-board engine models (OBEMs) 202 to generate estimated engine parameters representing the measured engine parameters (Pₘₐₛ) and implements a performance assessment module 304 to track performance related engine health. The OBEMs include a self-tuned engine model 202 (a.k.a. the closed-loop model), which is closed loop on the adjustments produced by the self-tuning module 300 and the long-term deterioration module 302. In addition to the tuning adjustments, the self-tuned closed-loop engine model 202 is configured to receive the engine parameters and a set of calibration adjustments to generate estimated engine parameters that can be further adjusted by another set of calibration adjustment to generate estimated engine parameters (P*ₑₛₜ) representing the measured engine parameters (Pₘₐₛ).

The self-tuned closed-loop model 202 incorporates the tuning adjustments to parameters in major modules of the engine, e.g., the efficiencies and flow capacities of the compressors and turbines. Instead of being aggregated, the adjustments are divided into two parts to account for engine short-term tuning and long-term deterioration separately. In this manner, the self-tuning capability of the OBEM 202 will be unaffected by the long-term engine deterioration that occurs over time.

The combination of the self-tuning module 300 and the long-term trending deterioration module 302 is configured to identify the engine long-term deterioration and separate it from the self-tuning capability. In this manner, the OBEMs can be tuned without influence from the long-term engine deterioration.

The self-tuning module 300 translates the residuals, namely the difference between (Pₘₐₛ) and (P*ₑₛₜ), to tuning parameters (Δη) which are in turn processed in the long-term deterioration module 302 for extraction of the long-term deterioration (Δη_{LT}). The long-term trending deterioration module 302 determines the long-term deterioration tuning parameters (Δη_{LT}) and outputs them along a first signal path to the Performance Assessment module 304 to track the engine health based on performance; a second signal path directly to the self-tuned engine model 202 to provide a separate tunning; and a third signal path for Δη_{LT} to be removed from the aggregated tuning parameters (Δη) to separate the long-term and short-term tuning. The difference, Δη−Δη_{LT}, is range-limited to prevent unexpected adjustments to the engine model 202, and the results become the short-term tuning parameter (Δη_{ST}), also fed to the model 202. In this manner, the self-tuned engine estimation module 108 can update the closed-loop self-tuned engine model 202 using the short-term tuning parameters (Δη_{sT}) independently from the long-term tuning parameters (Δη_{LT}). For example, the self-tuned engine model 202 is configured to receive both the short-term tuning parameters (Δη_{ST}) and the long-term deterioration (Δη_{LT}), where the long-term deterioration is incorporated into the base model to result in a model for deteriorated engine while the short-term tuning parameters (Δη_{ST}) are used to tune the self-tuned engine model 202 so that it matches the engine 102 being monitored and controlled. The self-tuning module 300 can be implemented as a Kalman Filter, for example, and is configured to determine—tuning parameters (Δη) indicative of the aggregated adjustments to the self-tuned engine model 202 for alignment with the engine 102 based on a difference (ΔP*) between the measured engine parameters (Pₘₐₛ) and tuned estimated engine parameters (P*ₑₛₜ).

According to one or more non-limiting embodiments, the long-term deterioration module 302 extracts long-term deterioration from (Δη) and compares the identified long-term deterioration against a predefined engine deterioration model implemented in the long-term deterioration module 302 to confirm its validity. The short-term tuning parameters (Δη_{ST}) is determined by removing the confirmed long-term deterioration parameters (Δη_{LT}) from the aggregated tuning parameters Δη and range-limiting the result. In this manner, the long-term deterioration parameter (Δη_{LT}) can be excluded from the self-tuning capability so that the short-term tuning parameters (Δη_{ST}) are not saturated by the range limits, and therefore avoid a diminished self-tuning capability found in conventional systems.

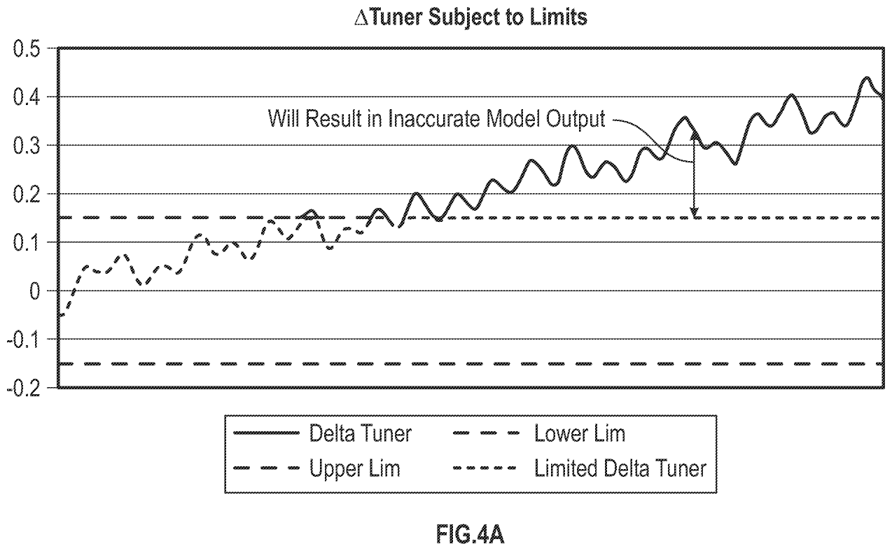

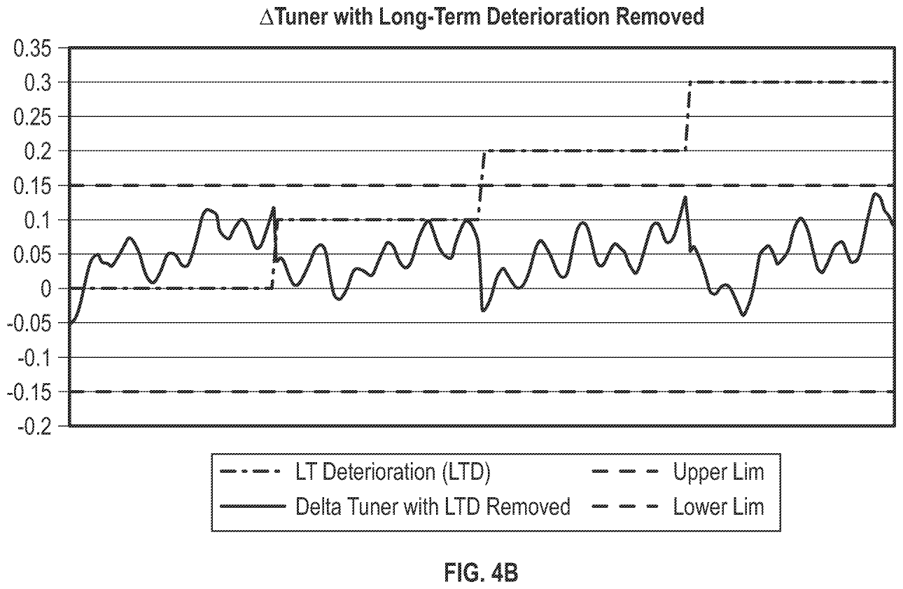

FIG. 4A, for example, is a signal diagram depicting a delta tuner function including long-term engine deterioration parameters (Δη_{LT}) and capped by parameter limits. To account for engine deterioration over time, delta tuners of conventional Kalman Filters are designed to accommodate the increasing difference between the engine and the model due to all sorts of uncertainties. However, the delta tuners will likely grow out of the limits imposed to prevent the model from getting to some undesired state. When the delta tuners are capped at the limits, the tuning capability will be diminished and the accuracy of the model output (e.g., estimated engine parameters) will be reduced, as shown in FIG. 4A.

As illustrated in FIG. 4B, however, removing or canceling the long-term deterioration (LTD) from the delta tuner of the Kalman Filter 300 as described according one or more non-limiting embodiments of the present disclosure will keep the latter remain within the limits while the self-tuning capability of the Kalman Filter 300 is fully retained. In this manner, the long-term deterioration is updated periodically as the engine 102 deteriorates over time while the short-term tuning parameters (Δη_{ST}) are varying continuously in real-time.

According to one or more non-limiting embodiments, the long-term deterioration and the delta tuner with the LTD removed by separation are essentially added back to tune the closed-loop self-tuning engine model 202. The outcome appears as an unlimited delta tuner being used to adjust the closed-loop self-tuning engine model 202. However, the benefit of separating the LTD from the delta tuner is to allow an additional assessment of LTD being incorporated other than a simple detrend. In one or more non-limiting embodiments, the function of the long-term deterioration trend can be examined with respect to the trend in delta tuner and assess the trend with the prior knowledge of deteriorated engines in the family. The result of this function is the identified long-term engine deterioration for the time period of interest.

Returning to FIG. 2, the performance assessment module 304 is configured to determine a performance change of the gas turbine engine based on the adjusted tuning parameters (Δη) and the long-term deterioration parameters (Δη_{LT}), and assesses a current performance of the engine 102. The assessed performance can include, but is not limited to, low/high compressor stall margins, Exhaust Gas Temperature (EGT) margins, performance degradation, and Specific Fuel Consumption (SFC).

As described herein, both the nominal engine model 200 and the self-tuned engine model 202 are calibrated for better alignment with the engine under monitoring and control. According to a non-limiting embodiment, the calibration of both the nominal engine model 200 and the self-tuned engine model 202 is regime-based and completely independent of the self-tuning function. According to a non-limiting embodiment, the different calibration could be applied to the nominal engine model 200 and the self-tuned engine model 202.

The regime recognition module 204 is configured to determine operating conditions at which the engine 102 is operating. The operating conditions include, for example, the determination of flight phase (e.g., ground idle, taxi-out, takeoff, climb, cruise, descent, approach, landing for a commercial airplane) and operational states (e.g., steady state, quasi-steady state, transient). Based on the current operating conditions, the regime recognition module 204 selects a given calibration model for calibrating the open-loop nominal engine model 200 and the closed-loop self-tuning engine model 202. According to a non-limiting embodiment, the regime recognition module 204 can selected two types of calibration models: an entry into service (EIS) Calibration Model (sometimes referred to as an “Acceptance Calibration Model”); and a Service Calibration Model.

The EIS Calibration Model is constructed based on test cell data from an acceptance test. Module performance is analyzed and converted to residuals compensation using engine performance influence coefficients. Engine installation effects are approximated and accommodated in this model. EIS Calibration Model provides fundamental Engine Model calibration and allows critical FD&I functions at EIS. The FD&I function is restricted to perform in prescribed operating regimes and is limited to detecting flight critical failures with minimal false alerts.

The Service Calibration Model is constructed based on flight data collected in service. According to a non-limiting embodiment, the regime recognition module can initiate a training mode, which allows collection of training data, for example, Pₘₐₛ and Pₑₛₜ, and can terminate the training mode when a training condition is met such as, for example, data coverage criteria are met, or a time window expires. According to a non-limiting embodiment, the Service Calibration Models can be trained and managed based on dynamically selected engine operation regimes described in greater detail below.

According to a non-limiting embodiment, the regime recognition module 204 performs a progressive learning process that allows the service calibration model to be gradually calibrated so that the performance of the service calibration model can be increasingly improved. For example, every engine will start at EIS with a corresponding model calibrated within a set of prescribed actionable regimes that is previously learned, e.g., during an Acceptance Test Program (ATP). While in service (e.g., during operation of the gas turbine engine 102), regime recognition module 204 will initiate a calibration adjustment mode only when the engine 102 is operating at operating conditions that have not occurred in the past or not previously observed by the regime recognition module 204. Any new model calibrations will then expand the scope of actionable regime associated with the selected calibration model, which allows more data points to be processed by the calibrated models for improved performance. In the case of an engine model that is undergoing calibration, the model-supported FD&I capability, engine parameter estimation, and performance trending will be carried out with the less calibrated model, but they will all be improved over time as the calibration model is calibrated with an ever-growing actionable regime.

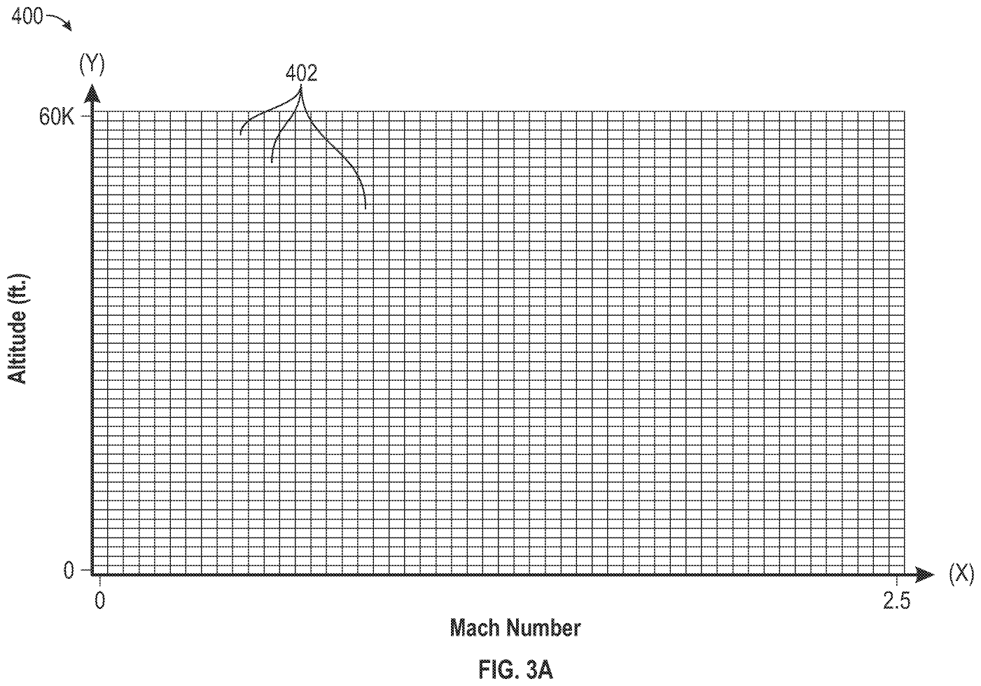

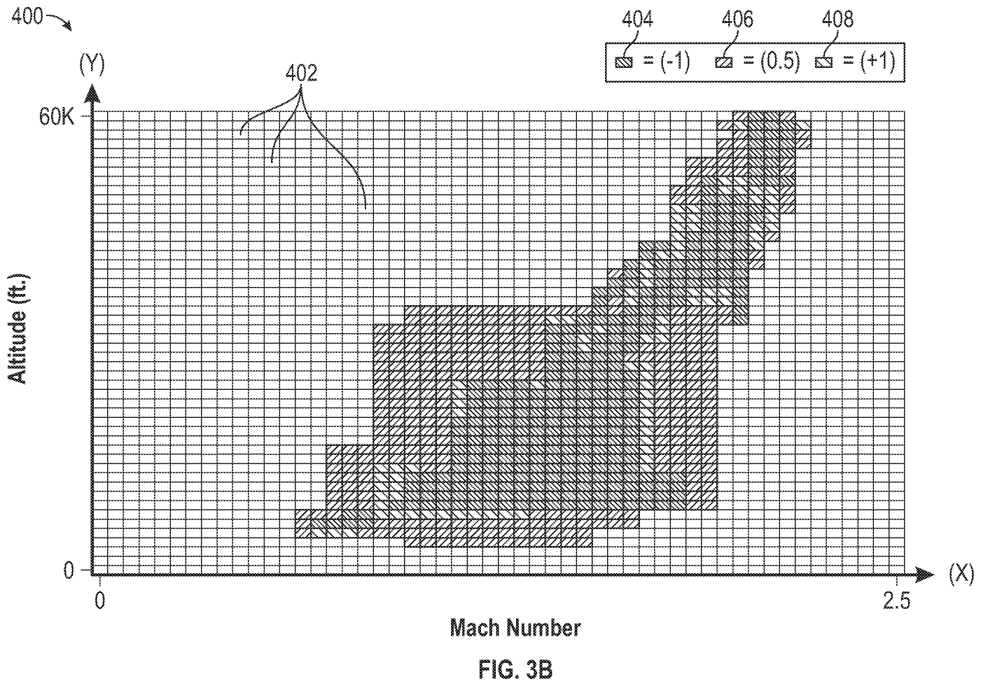

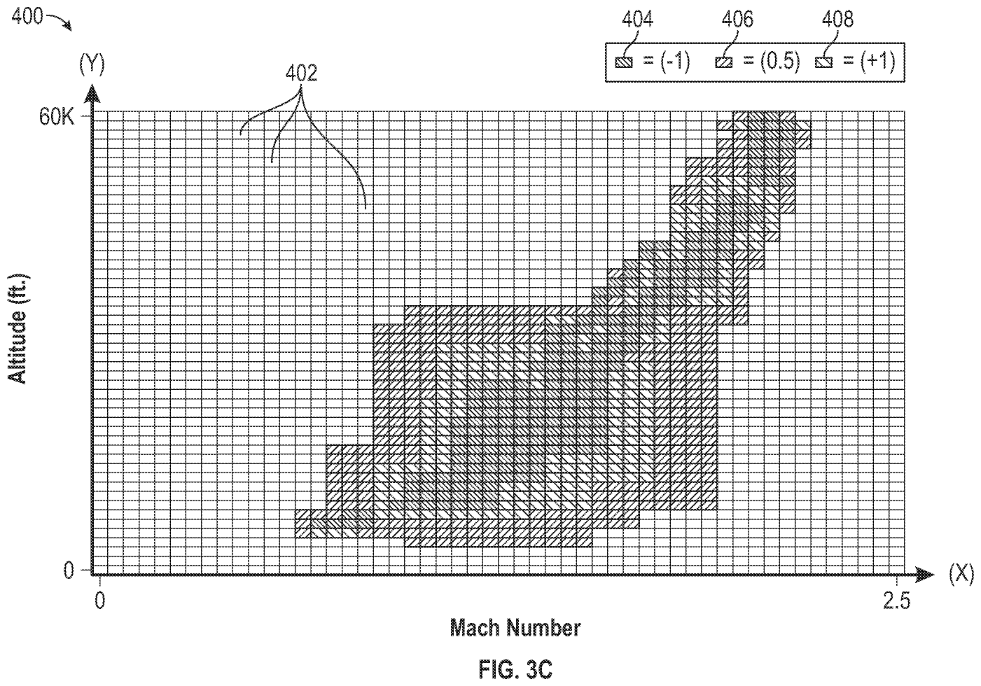

According to a non-limiting embodiment, the regime recognition module 204 is configured to perform a memory recall function to determine whether or not an operating condition has occurred in the past or has been previously observed. Referring to FIGS. 3A, 3B and 3C (collectively referred to as FIGS. 3A-3C), a memory map 400 utilized by the regime recognition module to perform the memory recall function is illustrated according to a non-limiting embodiment. The memory map 400 includes a plurality of cells 402 representing an individual engine operating condition. According to the example shown in FIGS. 3A-3C, each engine operating condition represented by a given cell 402 is defined by an altitude (defined along the Y-axis) at which the engine is operating with respect to a Mach value (defined along the X-axis) at which the engine is operating. It should be appreciated, however, that the X-axis and Y-axis of the memory map 400 can be assigned different variables without departing from the scope of the invention.

FIG. 3A illustrates the memory map 400 at entry into service (EIS). At this stage, the aircraft has not performed any flights. Therefore, the cells 402 of the memory map 400 are not filled. However, the memory map 400 “grows” as more data is collected during subsequently flights.

Referring to FIG. 3B, the memory map 400 is illustrated after a first number of flights (e.g., 10 flights). As the aircraft performs subsequent flights, the regime recognition module 204 identifies an engine input parameter set or operating condition among the identified current operating conditions of the aircraft and returns a confidence value indicating the likelihood that this data point has been observed by the regime recognition module 204 during a previous flight. For example, when the confidence value is below a threshold value and/or is a negative value, the regime recognition module 204 can identify or “flag” the engine input parameter set or operating condition(s) as not being previously identified. On the other hand, when the confidence value is above a threshold value and/or is a positive value, the regime recognition module 204 can identify or “flag” the engine input parameter set or operating condition(s) as now being identified or having occurred during operation of the gas turbine engine 102.

According to a non-limiting embodiment, the confidence value can range between −1 and 1, for example, where a higher value indicates a higher confidence that the given engine operating condition has been experienced or previously observed. In this example, first cells 404 designated with a first shading or first color (e.g., yellow), second cells 406 are designated with a second shading or second color (e.g., blue), and third cells 408 are designated with a third shading or third color (e.g., green). The first cells 404 are associated with a negative value (e.g., −1) indicating that the corresponding operating condition has likely not been previously observed. The second cells 406 are associated with a second positive value (e.g., 0.5) indicating that the corresponding operating condition has likely been previously observed. The third cells 408 are associated with a third positive value (e.g., 1) confirming that the corresponding operating condition has been previously observed. According to a non-limiting embodiment, the third positive value can meet or exceed a threshold value, thereby indicating that its associated operating condition or input parameter set has occurred and has been identified.

Referring to FIG. 3C, the memory map 400 is illustrated after the aircraft performs an additional number of flights (e.g., 20 flights). As shown in FIG. 3C, one or more cells 404 corresponding to an operating condition that was previously designated as likely not have been previously observed have now been identified. Accordingly, their corresponding confidence values have been increased and are now designated as likely to have been previously observed (e.g., cells 406) or confirmed to have been previously observed (e.g., cells 408). Similarly, one or more cells 406 corresponding to an operating condition that was previously designated as likely to have been previously observed have now been identified. Accordingly, their corresponding confidence values have been increased and are now designated confirmed to have been previously observed (e.g., cells 408). In this manner, the calibrated model is improved over time as it is calibrated with an ever-growing actionable regime.

According to a non-limiting embodiment, the memory recall function can be implemented as a neural network trained based on the frequency of clustered input data. The input parameters of the neural network can be assigned to the cells 402 to form a high dimensional grid defining the memory map 400. Accordingly, the frequency of data points hitting each cell 402 is normalized to form the confidence target. For repeatable missions or flights such as regular commercial flights, the neural network can train the recognition module 204 using the memory map 400 so that the recognition module 204 learns and remembers previously observed operating conditions sufficiently within a small number of flights, e.g., tens of flights. For less repeatable missions, such as those performed by military aircrafts, for example, the memory map 400 may appear sparser with only concentrated “memories” on common operational phases such as ground idle, takeoff and hover (for rotorcrafts).

Returning to FIG. 2, the fault detection and isolation module 110 uses the residual ΔP for fault detection and isolation. According to a non-limiting embodiment, the fault detection and isolation module 110 operates to detect and isolate an engine fault based at least in part on the parameter difference (ΔP) between the measured engine parameters (Pₘₐₛ) and the estimated nominal engine parameters (Pₑₛₜ). When a fault is detected, the fault detection and isolation module 110 can further operate to identify the particular type of the detected fault. The type of fault detected by the fault detection and isolation module 110 includes, but not limited to, faulty fuel flow, a LPC/HPC variable vane fault, a bleed air leakage, and sensor faults.

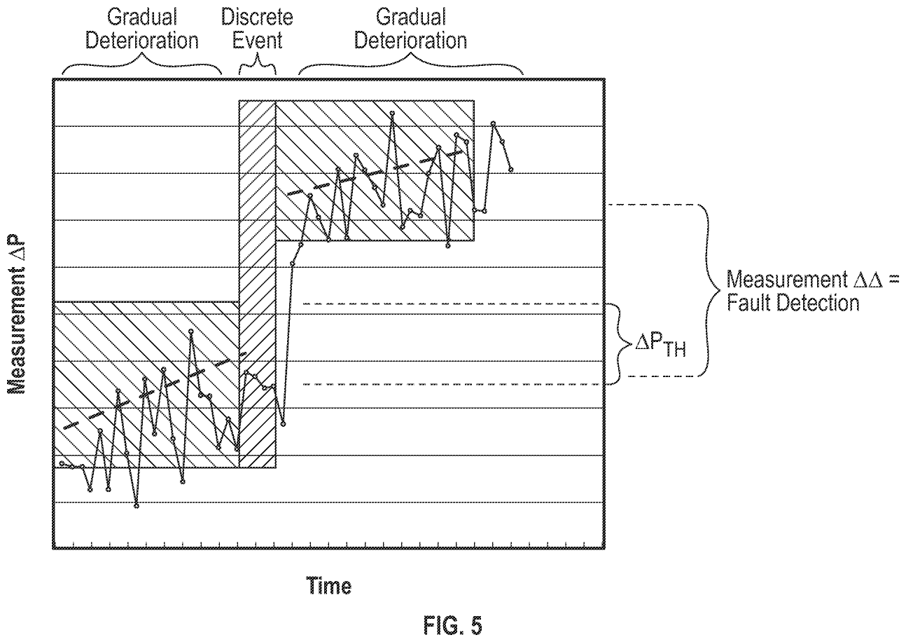

Turning to FIG. 5, an example of a signal diagram used by the fault detection and isolation module 110 to detect the presence of a fault is illustrated according to a non-limiting embodiment. The fault detection and isolation module 110 inputs a signal indicative of the engine parameter difference (ΔP) and continuously monitors it over a period of time. While the fault detection and isolation module 110 monitors the engine parameter difference (ΔP), a discrete event may occur during which parameter difference (ΔP) abruptly increases. When the increased parameter difference (ΔP) exceeds a differential threshold (ΔP_{TH}), the fault detection and isolation module 110 determines the presence of a fault and will move to isolate origin of the fault and/or identify the type of fault.

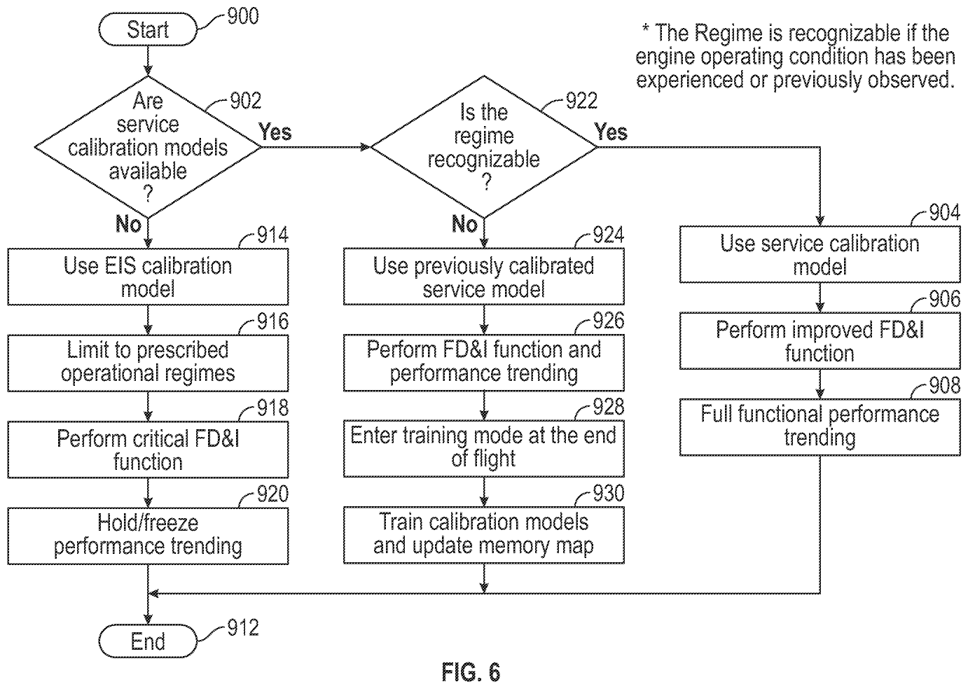

With reference now to FIG. 6, a method of using and training a service calibration model is illustrated according to a non-limiting embodiment. The method begins at operation 900 and at operation 902 determination is performed as to whether any calibrated service models is available. When one or more calibrated service models are available, the method proceeds to operation 922 to determine if the regime is recognizable, namely, if the engine operating condition has been experienced or previously observed. If the regime is recognized, the method proceeds to 904 to call the available calibrated service models for use. At operation 906, the Fault Detection and Isolation (FD&I) function is applied to the selected service calibration model. At operation 908, the full functional performance monitoring is conducted with the selected service calibration model, and the method ends at operation 912.

When, however, one or more calibrated service models are not available at operation 902, the method proceeds to operation 914 and limits the selected EIS calibration model to prescribed operational regimes. At operation 918, a Fault Detection and Isolation (FD&I) function is applied to the selected EIS calibration model. At operation 920, the performance trending of the selected EIS calibration model placed on hold or “paused” and the method ends at operation 912.

In addition, when one or more calibrated service models are available at operation 902, but the regime is not recognizable at operation 922, the method proceeds to operation 924 to call for use of previously calibrated service model and perform FD&I as well as performance trending at operation 926. In this case, one or more service calibration models require training, and the training mode is initiated at operation 928 upon completion of the flight. The service models are trained, and the memory map corresponding to the service calibration model is updated at operation 930. The method ends at operation 912.

As described herein one or more non-limiting embodiments of the disclosure provide a self-calibrating dynamic model that can be used upon engine EIS and calibrated only when needed. The self-calibrating dynamic model can perform calibration of a nominal and self-tuning engine models as they are used for FD&I and performance assessment. The self-calibrating dynamic model also can separate the long-term tuning parameters and the short-term tuning parameters from one another so that the self-tuning capability is not compromised or diminished as the engine deteriorates.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to the particular embodiment disclosed as the best mode contemplated for carrying out this present disclosure, but that the present disclosure will include all embodiments falling within the scope of the claims.

What is claimed is:

1. An engine model calibration system comprising:
a gas turbine engine configured to operate according to one or more engine operating parameters;
a sensor configured to monitor the gas turbine engine and output measured parameters indicative of the one or more engine operating parameters;
a nominal engine estimation module including an open-loop nominal engine model configured to output estimated nominal engine parameters indicative of the one or more engine operating parameters,
wherein the nominal engine estimation module identifies one or more engine operating conditions of the gas turbine engine based on the one or more engine operating parameters and selectively updates the open-loop nominal engine model based on the identified one or more engine operating conditions.

2. The engine model calibration system of claim 1, further comprising a self-tuned engine estimation module including a closed-loop self-tuned engine model configured to output estimated self-tuned engine parameters indicative of the one or more engine operating parameters, wherein the self-tuned engine estimation module updates the closed-loop self-tuned engine model based on short-term tuning parameters and long-term tuning parameters.

3. The engine model calibration system of claim 2, wherein the self-tuned engine estimation module further comprises:
a self-tuning module configured to determine adjusted tuning parameters indicative of aggregated adjustments to the closed-loop self-tuned engine model based a difference between the measured parameters and the estimated self-tuned engine parameters; and
a long-term trending deterioration module configured to determine long-term tuning parameters based on the adjusted tuning parameters and to determine the short-term tuning parameters based on a difference between the adjusted tuning parameters and the long-term tuning parameters.

4. The engine model calibration system of claim 3, wherein the self-tuned engine estimation module updates the closed-loop self-tuned engine model using the short-term tuning parameters independently from the long-term tuning parameters.

5. The engine model calibration system of claim 1, wherein the nominal engine estimation module further comprises:
a regime recognition module that identifies the engine operating conditions; and
a calibration adjustment module configured to selectively update the open-loop nominal engine model and the closed-loop self-tuned engine model based on the one or more engine operating conditions identified by the regime recognition module.

6. The engine model calibration system of claim 5, wherein the regime recognition module selects a given calibration model among a plurality of different calibration models based on the identified one or more engine operating conditions, and delivers the selected calibration model to the calibration adjustment module, and
wherein the calibration adjustment module updates the open-loop nominal engine model and the closed-loop self-tuned engine model based on the selected calibration model.

7. The engine model calibration system of claim 6, wherein the plurality of different calibration models include an entry into service model that is constructed based on test cell data generated according to an acceptance test, and a service calibration model that is constructed based on flight data collected during operation of the gas turbine engine.

8. The engine model system of claim 6, wherein the regime recognition module initiates a calibration adjustment mode to calibrate the open-loop nominal engine model and the closed-loop self-tuned engine model in response to determining that the identified one or more engine operating conditions were not previously identified.

9. The engine model system of claim 8, wherein the regime recognition module assigns confidence values to the operating conditions of the gas turbine engine and determines when the identified one or more engine operating conditions were not previously identified based the confidence values and a threshold value.

10. The engine model system of claim 9, wherein in response to initiating the calibration mode, the regime recognition module increases the confidence value of the identified operating conditions.

11. A method of calibrating an engine model representing a gas turbine engine configured to operate according to one or more engine operating parameters, the method comprising:
monitoring, via a sensor, the gas turbine engine and outputting from the sensor measured parameters indicative of the one or more engine operating parameters; and
outputting, via a nominal engine estimation module including an open-loop nominal engine model, estimated nominal engine parameters indicative of the one or more engine operating parameters,
identifying, via the nominal engine estimation module, one or more engine operating conditions of the gas turbine engine based on the one or more engine operating parameters; and
selectively updating the open-loop nominal engine model based on the identified one or more engine operating conditions.

12. The method of claim 11, further comprising outputting, via a self-tuned engine estimation module including a closed-loop self-tuned engine model, estimated self-tuned engine parameters indicative of the one or more engine operating parameters; and
updating the closed-loop self-tuned engine model based on short-term tuning parameters and long-term tuning parameters.

13. The method of claim 12, further comprising:
determining, via a self-tuning module, adjusted tuning parameters indicative of aggregated adjustments to the closed-loop self-tuned engine model based on a difference between the measured parameters and the estimated self-tuned engine parameters;
determining, via a long-term trending for deterioration module, the long-term tuning parameters based on the adjusted tuning parameters; and
determining the short-term tuning parameters based on a difference between the adjusted tuning parameters and the long-term tuning parameters.

14. The method of claim 13, wherein the self-tuned engine estimation module updates the closed-loop self-tuned engine model using the short-term tuning parameters independently from the long-term tuning parameters.

15. The method of claim 11, further comprising:
identifying, via a regime recognition module, the engine operating conditions; and
selectively updating the open-loop nominal engine model and the closed-loop self-tuned engine model using a calibration adjustment model based on the one or more engine operating conditions identified by the regime recognition module.

16. The method of claim 15, further comprising selecting, via the regime recognition module, a given calibration model among a plurality of different calibration models based on the identified one or more engine operating conditions;
delivering the selected calibration model to the calibration adjustment module, and
updating, via the calibration adjustment module, the open-loop nominal engine model and the closed-loop self-tuned engine model based on the selected calibration model.

17. The method of claim 16, wherein the plurality of different calibration models includes an entry into service model that is constructed based on test cell data generated according to an acceptance test, and a service calibration model that is constructed based on flight data collected during operation of the gas turbine engine.

18. The method of claim 16, further comprising initiating, via the regime recognition module, a calibration adjustment mode to calibrate the open-loop nominal engine model and the closed-loop self-tuned engine model in response to determining that the identified one or more engine operating conditions were not previously identified.

19. The method of claim 18, further comprising:
assigning, via the regime recognition module, confidence values to the operating conditions of the gas turbine engine; and
determining, via the regime recognition module, when the identified one or more engine operating conditions were not previously identified based the confidence values and a threshold value.

20. The method of claim 19, wherein in response to initiating the calibration mode, the regime recognition module increases the confidence value of the identified operating conditions.
